(19) United States
(12) Patent Application Publication
(10) Pub. No.: US 2019/0026638 A1
(43) Pub. Date: Jan. 24, 2019

(54) KNOWLEDGE VERIFICATION METHOD, KNOWLEDGE VERIFICATION DEVICE AND STORAGE MEDIUM

(71) Applicant: BOE TECHNOLOGY GROUP CO., LTD., Beijing (CN)

(72) Inventors: Zhenzhong ZHANG, Beijing (CN); Xue Chen, Beijing (CN)

(21) Appl. No.: 15/981,216

(22) Filed: May 16, 2018

(30) Foreign Application Priority Data
Jul. 24, 2017 (CN) 201710606293.1

(51) Int. Cl. G06N 5/04; G06N 7/00

(52) U.S. Cl. CPC G06N 5/046; G06N 7/005

(57) ABSTRACT

A knowledge verification method, a knowledge verification device, and a storage medium. The knowledge verification method includes: obtaining target candidate knowledge and conflict candidate knowledge that contradicts with the target candidate knowledge; obtaining a target evidence group related to the target candidate knowledge and a conflict evidence group related to the conflict candidate knowledge; calculating a verification probability of the target candidate knowledge based on a logic rule of each evidence in the target evidence group and calculating a verification probability of the conflict candidate knowledge based on a logic rule of each evidence in the conflict evidence group; and comparing the verification probability of the target candidate knowledge with the verification probability of the conflict candidate knowledge and determining whether the target candidate knowledge is correct knowledge or not according to a comparison result.

The present application claims priority to Chinese patent application No. 201710606293.1, filed Jul. 24, 2017, the entire disclosure of which is incorporated herein by reference as part of the present application.

### TECHNICAL FIELD

Embodiments of the present disclosure relate to a knowledge verification method, a knowledge verification device, and a storage medium.

### BACKGROUND

In scientific research, Internet applications, electronic commerce and other fields, data sizes, data types and the like are rapidly growing, and big data has gradually become a research hotspot. The big data refers to data sets that cannot be captured, managed, and processed by conventional software tools within a certain period of time. The big data has characteristics of a large data size, many types of data, a fast data processing speed, a low data-value density and so on.

The big data comprises structured data, semi-structured data, and unstructured data. With the rapid development of social networks, Internet of things, cloud computing and the like, the unstructured data grows exponentially due to its characteristics such as huge data, large varieties and strong timeliness, and the unstructured data has gradually become mainstream data in an era of big data.

### SUMMARY

As least one embodiment of the present disclosure provides a knowledge verification method, which comprises: obtaining target candidate knowledge and conflict candidate knowledge that contradicts with the target candidate knowledge; obtaining a target evidence group related to the target candidate knowledge and a conflict evidence group related to the conflict candidate knowledge; calculating a verification probability of the target candidate knowledge based on a logic rule of each evidence in the target evidence group and calculating a verification probability of the conflict candidate knowledge based on a logic rule of each evidence in the conflict evidence group; and comparing the verification probability of the target candidate knowledge with the verification probability of the conflict candidate knowledge and determining whether the target candidate knowledge is correct knowledge or not according to a comparison result.

At least one embodiment of the present disclosure further provides a knowledge verification device, which comprises a processor and a storage, the storage is used for storing non-transitory computer-readable instructions; and the non-transitory computer-readable instructions, as executed by the processor, cause the processor to perform steps including: obtaining target candidate knowledge and conflict candidate knowledge that contradicts with the target candidate knowledge; obtaining a target evidence group related to the target candidate knowledge and a conflict evidence group related to the conflict candidate knowledge; calculating a verification probability of the target candidate knowledge based on a logic rule of each evidence in the target evidence group and calculating a verification probability of the conflict candidate knowledge based on a logic rule of each evidence in the conflict evidence group; and comparing the verification probability of the target candidate knowledge with the verification probability of the conflict candidate knowledge and determining whether the target candidate knowledge is correct knowledge or not according to a comparison result.

At least one embodiment of the present disclosure further provides a storage medium, used for storing non-transitory computer-readable instructions, the non-transitory computer-readable instructions, as executed by a processor, cause the processor to perform steps including: obtaining target candidate knowledge and conflict candidate knowledge that contradicts with the target candidate knowledge; obtaining a target evidence group related to the target candidate knowledge and a conflict evidence group related to the conflict candidate knowledge; calculating a verification probability of the target candidate knowledge based on a logic rule of each evidence in the target evidence group and calculating a verification probability of the conflict candidate knowledge based on a logic rule of each evidence in the conflict evidence group; and comparing the verification probability of the target candidate knowledge with the verification probability of the conflict candidate knowledge and determining whether the target candidate knowledge is correct knowledge or not according to a comparison result.

### BRIEF DESCRIPTION OF THE DRAWINGS

In order to clearly illustrate the technical solutions of the embodiments of the disclosure, the drawings of the embodiments will be briefly described in the following; it is obvious that the described drawings are only related to some embodiments of the disclosure and thus are not limitative to the disclosure.

FIG. 1 is a schematic flow chart of a knowledge verification method provided by an embodiment of the present disclosure;

FIG. 2A is a schematic block diagram of a target evidence group/a conflict evidence group provided by an embodiment of the present disclosure;

FIG. 2B is a schematic block diagram of logic rules of a target evidence group/a conflict evidence group provided by an embodiment of the present disclosure;

FIG. 3 is a schematic flow chart of another knowledge verification method provided by an embodiment of the present disclosure;

FIG. 4A is a schematic block diagram of an example of a target evidence group provided by an embodiment of the present disclosure;

FIG. 4B is a schematic block diagram of an example of a conflict evidence group provided by an embodiment of the present disclosure;

FIG. 5 is a schematic flow chart of yet another knowledge verification method provided by an embodiment of the present disclosure;

FIG. 6 is a schematic flow chart of still yet another knowledge verification method provided by an embodiment of the present disclosure; and

FIG. 7 is a schematic block diagram of a knowledge verification device provided by an embodiment of the present disclosure.

### DETAILED DESCRIPTION

In order to make objects, technical details and advantages of the embodiments of the disclosure apparent, the technical solutions of the embodiments will be described in a clearly and fully understandable way in connection with the drawings related to the embodiments of the disclosure. Apparently, the described embodiments are just a part but not all of the embodiments of the disclosure. Based on the described embodiments herein, those skilled in the art can obtain other embodiment(s), without any inventive work, which should be within the scope of the disclosure.

Unless otherwise defined, all the technical and scientific terms used herein have the same meanings as commonly understood by one of ordinary skill in the art to which the present disclosure belongs. The terms “first,” “second,” etc., which are used in the present disclosure, are not intended to indicate any sequence, amount or importance, but distinguish various components. The terms “comprise,” “comprising,” “include,” “including,” etc., are intended to specify that the elements or the objects stated before these terms encompass the elements or the objects and equivalents thereof listed after these terms, but do not preclude the other elements or objects. The phrases “connect”, “connected”, etc., are not intended to define a physical connection or mechanical connection, but may include an electrical connection, directly or indirectly. “On,” “under,” “right,” “left” and the like are only used to indicate relative position relationship, and when the position of the object which is described is changed, the relative position relationship may be changed accordingly. In order to make the following description of the embodiments of the present disclosure clear and concise, the present disclosure omits a detailed description of known functions and known components.

With the rapid development of cloud computing, people pay more and more attention to big data. The big data era has brought in two effects: on one hand, the increase of data can satisfy people's different needs of information; on the other hand, useful information and knowledge are buried in a large amount of irrelevant data. Automatic extraction of knowledge in a specific domain from massive amounts of unstructured data can help people quickly master knowledge and understand the knowledge in depth. However, among various types of knowledge that are automatically extracted from the massive data, conflicting and contradictory knowledge may exist. Currently, the right or wrong of the extracted various types of knowledge is usually judged by experts in the particular fields, so as to solve a problem of knowledge conflict. A judging method based on experts in the particular fields takes a great deal of time and manpower, and is not suitable for the judgment of massive knowledge in the big data era.

At least one embodiment of the present disclosure provides a knowledge verification method, a knowledge verification device and a storage medium. The knowledge verification method can model logic rules of respective evidences of candidate knowledge, and calculate a verification probability of the candidate knowledge according to the logic rules of respective evidences, so as to automatically verify the correctness of the candidate knowledge, and to solve a knowledge conflict problem and save manpower and time costs. For example, the knowledge verification method provided by an embodiment of the present disclosure can automatically analyze, process, and obtain useful knowledge from massive unstructured big data, and verify the correctness of the obtained knowledge.

A knowledge verification method, a knowledge verification device, and a storage medium provided by some embodiments of the present disclosure will be described in detail below with reference to the accompanying drawings.

FIG. 1 shows a schematic flow chart of a knowledge verification method provided by an embodiment of the present disclosure.

For example, as shown in FIG. 1, the knowledge verification method provided by an embodiment of the present disclosure may comprises the following steps:

Step S11: obtaining target candidate knowledge and conflict candidate knowledge that contradicts with the target candidate knowledge;

Step S12: obtaining a target evidence group related to the target candidate knowledge and a conflict evidence group related to the conflict candidate knowledge;

Step S13: calculating a verification probability of the target candidate knowledge based on a logic rule of each evidence in the target evidence group and calculating a verification probability of the conflict candidate knowledge based on a logic rule of each evidence in the conflict evidence group; and

Step S14: comparing the verification probability of the target candidate knowledge with the verification probability of the conflict candidate knowledge and determining whether the target candidate knowledge is correct knowledge or not according to a comparison result.

For example, a basic idea of a Markov logic network is that when an event violates a logic rule in a series of logic rules, a probability of existence of the event is decreased, but the existence of the event is not impossible. The less logic rules an event violates, the greater the probability of the existence of the event is. Therefore, each logic rule has a specific weight, and the weight reflects a binding force on a possible event that satisfies the logic rule. If the weight of a logic rule is greater, a difference between an event that satisfies the logic rule and another event that does not satisfy the logic rule is greater. Compatibility among the target candidate knowledge (or the conflict candidate knowledge), existing correct knowledge and the data source depends on how many logic rules the target candidate knowledge (or the conflict candidate knowledge) violates and importance of the violated logic rules.

The knowledge verification method provided by an embodiment of the present disclosure may model logic rules between the candidate knowledge and the extracted evidence group (for example, the logic rules between the target candidate knowledge and the target evidence group, and the logic rules between the conflict candidate knowledge and the conflict evidence group) through a Markov logic network, calculate a verification probability of the extracted target candidate knowledge and a verification probability of the extracted conflict candidate knowledge based on the logic rules of respective evidences in the evidence group, and determine whether the extracted target candidate knowledge is correct knowledge or not according to a comparison result between the verification probability of the target candidate knowledge and the verification probability of the conflict candidate knowledge. For example, in the step S11, the target candidate knowledge and the conflict candidate knowledge are extracted from the data source. The data source may be composed of unstructured data.

For example, the data source may be a separate knowledge set of different types of knowledge, such as a medical knowledge set, a literary knowledge set, a historical knowledge set, a physical knowledge set. For another example, the data source may also be a mixed set of different types of knowledge (such as, physics, history, math, etc.).

For example, various kinds of unstructured data in the data source can be various kinds of knowledge extracted from different sources. Sources of various kinds of knowledge may be textbooks, websites, essays and literary works. For example, when the data source is the medical knowledge set, sources of the medical knowledge may be medical websites, medical essays, medical textbooks, medical records, and so on.

For example, in the descriptions of the present disclosure, a data source is a medical knowledge set which is taken as an example to describe the knowledge verification method provided by an embodiment of the present disclosure in detail. But a person having ordinary skill in the art should know that the data source can also be other types of data sources.

For example, multiple pieces of candidate knowledge may be extracted from the data source to form a candidate knowledge group; for another example, the candidate knowledge group may also include all candidate knowledge in the data source. The target candidate knowledge and the conflict candidate knowledge both may be selected from the candidate knowledge group.

For example, the multiple pieces of candidate knowledge in the candidate knowledge group may comprise “Vitamin C can prevent catching a cold”, “Calcium helps prevent osteoporosis”, “Vitamin C cannot prevent catching a cold”, “dried small shrimps can prevent osteoporosis”, “lemon can prevent catching a cold” and the like. For example, the candidate knowledge group may comprise a lot of knowledge that contradict with each other, for example, “Vitamin C can prevent catching a cold” and “Vitamin C cannot prevent catching a cold” in the above candidate knowledge group are contradictory knowledge. When “Vitamin C can prevent catching a cold” is selected as the target candidate knowledge, “Vitamin C cannot prevent catching a cold” is the conflict candidate knowledge.

For example, a natural language processing (NLP) technology can be used to extract the target candidate knowledge and the conflict candidate knowledge from the data source.

For example, the natural language processing technology may comprise syntactic parsing, word segmentation, lexical analysis, semantic analysis, word recognition and other language processing technologies. For example, the natural language processing technology can perform language processing by using deep learning neural networks and other methods. The accuracy of the selected target candidate knowledge and/or the selected conflict candidate knowledge can be improved by using the deep learning neural networks to process unstructured data in the data source.

For example, the deep learning neural network may comprise a neural network such as a recurrent neural network (RNN) and a recursive neural network (RNN). The recurrent neural networks can be used for word representation, statement legitimacy check, vocabulary-property tagging and other natural language processing. The recurrent neural network may comprise a long short-term memory (LSTM) neural network. The long short-term memory neural network has the ability to learn long-term dependence, and the long short-term memory neural network can use a relative wide range of contextual information in text processing to determine a probability of a next word. The deep learning neural network, for example, may adopt one or several of the above neural networks to process and analyze the natural language.

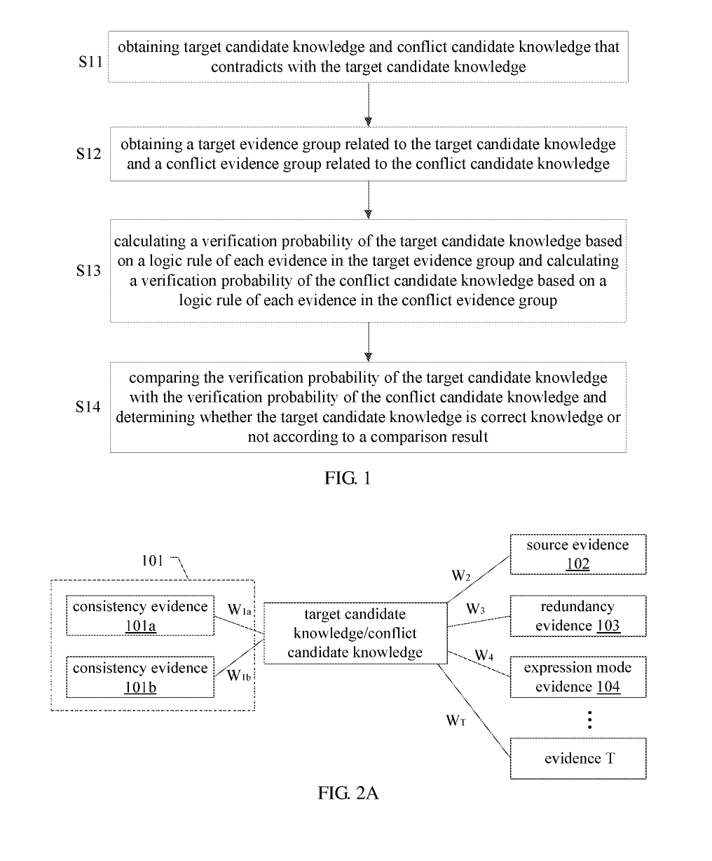

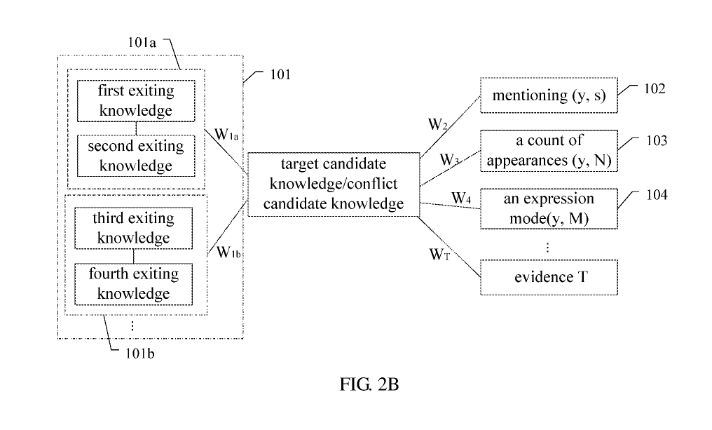

FIG. 2A is a schematic block diagram of a target evidence group/a conflict evidence group provided by an embodiment of the present disclosure; and FIG. 2B is a schematic block diagram of logic rules of a target evidence group/a conflict evidence group provided by an embodiment of the present disclosure.

For example, in the step S12, the target evidence group may be used to determine likelihood that the target candidate knowledge is right, and the conflict evidence group may be used to determine likelihood that the conflict candidate knowledge is right. However, the present disclosure does not limit thereto, the target evidence group may also be used to determine likelihood that the target candidate knowledge is wrong, and the conflict evidence group may be used to determine likelihood that the conflict candidate knowledge is wrong.

The knowledge verification method provided by an embodiment of the present disclosure can model logic rules of respective evidences of the candidate knowledge, and calculate a verification probability of the candidate knowledge according to the logic rules of respective evidences, so as to automatically analyze, process, obtain useful knowledge from massive and unstructured big data, verify the correctness of the obtained knowledge, solve the knowledge conflict problem and save manpower and time costs.

For example, as shown in FIG. 2A, each evidence group may comprise at least one of a source evidence 102, a redundancy evidence 103 and an expression mode evidence 104 (for example, the target evidence group may comprise at least one of the source evidence 102, the redundancy evidence 103 and the expression mode evidence 104; meanwhile, the conflict evidence group may comprise at least one of the source evidence 102, the redundancy evidence 103 and the expression mode evidence 104). For example, for the source evidence 102, the source evidence 102 in the target evidence group represents a source of the target candidate knowledge, and the source evidence 102 in the conflict evidence group represents a source of the conflict candidate knowledge. For example, the source evidence 102, the redundancy evidence 103 and the expression mode evidence 104 all may be obtained from data sources.

It should be noted that, the target evidence group and the conflict evidence group may also respectively comprise a plurality of evidences (such as, an evidence T shown in FIG. 2A) obtained from the data sources. The embodiments of the present disclosure do not limit specific types of evidences in the target evidence group and in the conflict evidence group. Evidence types of the target evidence group and evidence types of the conflict evidence group may be the same.

For example, the source evidence 102 may comprise a plurality of evidences which come from different sources. The source evidence 102, for example, may comprise a first source evidence and a second source evidence, and the first source evidence and the second source evidence come from a medical textbook and a medical essay respectively.

For example, as shown in FIG. 2A, both the target evidence group and the conflict evidence group may also comprise a consistency evidence 101. For example, the consistency evidence 101 may be obtained from an existing knowledge repository. The existing knowledge repository, for example, may represent a collection of all or a part of the existing correct knowledge.

For example, the existing knowledge repository and the data sources may be selected according to the target candidate knowledge and the conflict candidate knowledge. For example, in a case that the target candidate knowledge is medical knowledge, the data sources may be a collection of medical knowledge, and the existing knowledge repository may be a collection of existing correct medical knowledge.

For example, evidences in the target evidence group and evidences in the conflict evidence group correspond to each other and have the same quantity.

For example, respective evidences in the target evidence group and respective evidences in the conflict evidence group may also be obtained from the data source and/or the existing knowledge repository by using the natural language processing technology such as the deep learning neural network.

For example, as shown in FIG. 2B, a logic rule of the source evidence 102 may be expressed as: mentioning (y, s); a logic rule of the redundancy evidence 103 may be expressed as: a count of appearances (y, N); a logic rule of the expression mode evidence 104 may be expressed as: an expression mode (y, M); and a logic rule of the consistency evidence 101 may be expressed as: first existing knowledge A second existing knowledge=>y.

For example, in a case that y represents target candidate knowledge, S represents a source of the target candidate knowledge, N represents a count of appearances of the target candidate knowledge, M represents a quantity of different expression modes of the target candidate knowledge; in a case that y represents conflict candidate knowledge, S represents a source of the conflict candidate knowledge, N represents a count of appearances of the conflict candidate knowledge, M represents a quantity of different expression modes of the conflict candidate knowledge.

For example, a basic idea of the source evidence 102 is that: the authority of an information source (namely, the source of knowledge) is higher, the likelihood that correct knowledge appears is larger.

For example, when y is the target candidate knowledge, a weight W₂ of the source evidence 102 may be represented as an authority of S, and the authority of S is higher, the probability that the target candidate knowledge is right is larger. Weights W₂ of source evidences 102 from different sources may be different or the same. A weight W₂ of a source evidence 102 may be predefined. For example, when S is a medical textbook, the weight W₂ of S may be 10; when S is a medical essay, the weight W₂ of S also may be 10; when S is a medical record, the weight W₂ of S may be 9; and when S is a medical website, the weight W₂ of S may be 5.

For example, assume that the target candidate knowledge (such as, “Vitamin C can prevent catching a cold”) is obtained from a medical website, but the conflict candidate knowledge (such as, “Vitamin C cannot prevent catching a cold”) is obtained from a medical textbook. Therefore, the weight W₂ of the source evidence 102 of the target candidate knowledge is 5, and the weight W₂ of the source evidence 102 of the conflict candidate knowledge is 10, so that a probability that the target candidate knowledge (such as, “Vitamin C can prevent catching a cold”) is right is less than a probability that the conflict candidate knowledge (such as, “Vitamin C cannot prevent catching a cold”) is right.

For example, a basic idea of the redundancy evidence 103 is that: relative to wrong knowledge, correct knowledge may appear in more information sources.

For example, a weight W₃ of the redundancy evidence 103 may be represented as logₐN.

For example, if the target candidate knowledge (such as, “Vitamin C can prevent catching a cold”) appears in 8 medical textbooks, but the conflict candidate knowledge (such as, “Vitamin C cannot prevent catching a cold”) appears in 16 medical textbooks. Therefore, if a is equal to 2, the weight W₃ of the redundancy evidence 103 of the target candidate knowledge is log₂8=3, and the weight W₃ of the redundancy evidence 103 of the conflict candidate knowledge is log₂16=4, so that a probability that the target candidate knowledge (such as, “Vitamin C can prevent catching a cold”) is right is less than a probability that the conflict candidate knowledge (such as, “Vitamin C cannot prevent catching a cold”) is right.

For example, a basic idea of the expression mode evidence 104 is that: relative to the wrong knowledge, the right knowledge may be expressed in more different modes.

For example, a weight W₄ of the expression mode evidence 104 may be expressed as logₐM.

For example, for the target candidate knowledge (such as, “Vitamin C can prevent catching a cold”), four different expression modes, such as “Vitamin C can effectively prevent a cold”, “Eating Vitamin C can prevent a cold” and the like, may exist in the whole data sources; for the conflict candidate knowledge (such as, “Vitamin C cannot prevent catching a cold”), eight different expression modes, such as “Vitamin C has little effect on prevention and treatment of a cold”, “Taking Vitamin C has no effect on prevention and treatment of a cold” and the like, may exist in the whole data sources. Therefore, if a is equal to 2, the weight W₄ of the expression mode evidence 104 of the target candidate knowledge is log₂4=2, and the weight W₄ of the expression mode evidence 104 of the conflict candidate knowledge is log₂8=3, so that a probability that the target candidate knowledge (such as, “Vitamin C can prevent catching a cold”) is right is less than a probability that the conflict candidate knowledge (such as, “Vitamin C cannot prevent catching a cold”) is right.

It should be noted that, in the above descriptions, logₐ represents a logarithmic function with “a” as a base. The weight W₃ of redundancy evidence 103 and the weight W₄ of the expression mode evidence 104 are not limited to the above function expressions, and the weight W₃ of redundancy evidence 103 and the weight W₄ of the expression mode evidence 104 may have other function expressions. For instance, the weight W₃ of redundancy evidence 103 may be expressed as \sqrt{N}, and the weight W₄ of the expression mode evidence 104 may be expressed as \sqrt{M}.

For example, a basic idea of the consistency evidence 101 is that: relative to the wrong knowledge, the right knowledge should be compatible with the existing correct knowledge, that is, the correct knowledge should not conflict with the existing correct knowledge. The logic rule of the consistency evidence 101 is expressed as “first existing knowledge A second existing knowledge=>y”, which may represent that candidate knowledge y (for example, y may be the target candidate knowledge or the conflict candidate knowledge) can be derived from the first existing knowledge and the second existing knowledge. That is, the candidate knowledge y does not conflict with both the first existing knowledge and the second existing knowledge.

For example, in the logic rule of the consistency evidence 101, the first existing knowledge and the second existing knowledge both are knowledge in the existing knowledge repository, that is, the first existing knowledge and the second existing knowledge are existing correct knowledge. The logic rule of the consistency evidence 101 is a constraint rule between the existing correct knowledge and the target candidate knowledge. For example, assume that the target candidate knowledge is “dried small shrimps can prevent osteoporosis”, the conflict candidate knowledge is “dried small shrimps cannot prevent osteoporosis”, the existing knowledge repository comprises the first existing knowledge and the second existing knowledge, and the first existing knowledge is “dried small shrimps include calcium”, and the second existing knowledge is “calcium can prevent osteoporosis”. Therefore, according to the logic rule of the consistency evidence 101 (that is, first existing knowledge A second existing knowledge=>y), it can be derived that y is “dried small shrimps can prevent osteoporosis”, so that the target candidate knowledge does not conflict with the existing correct knowledge, the conflict candidate knowledge conflicts with the existing correct knowledge, and the probability that the target candidate knowledge is right is larger than the probability that the conflict candidate knowledge is right.

For example, in an example, the first existing knowledge may be expressed as “containing (K,M)”, the second existing knowledge may be expressed as “prevention (M,D)”, and y may be expressed as “prevention (K,D)”, here, K may be food, medicine, etc., M may be an element, a substance and the like contained in K, and D may be a symptom, a disease, or the like. Therefore, the logic rule of the consistency evidence 101 can be modeled as “containing (K,M) A prevention (M,D)=>prevention (K,D)”. For example, the first existing knowledge is “Lemon contains a large amount of Vitamin C”, the second existing knowledge is “Vitamin C can prevent catching a cold”, y is “Lemon can prevent catching a cold”, then the logic rule of the consistency evidence 101 is expressed as: containing (lemon, Vitamin C) A prevention (Vitamin C, cold)=>prevention (lemon, cold).

For example, a weight W₁ of the consistency evidence 101 is a logical value of the logic rule of the consistency evidence 101. For example, when the logical value is true, the weight W₁ is 1, and when the logical value is false, the weight W₁ is 0. For example, the target candidate knowledge is “Lemon can prevent catching a cold”, and the conflict candidate knowledge is “Lemon cannot prevent catching a cold”. If the first existing knowledge is “Lemon contains a large amount of Vitamin C”, the second existing knowledge is “Vitamin C can prevent catching a cold”. Based on the logic rule of the consistency evidence 101, a weight W₁ of the consistency evidence 101 of the target candidate knowledge is 1, a weight W₁ of the consistency evidence 101 of the conflict candidate knowledge is 0, so that the probability that target candidate knowledge is right is greater than the probability that the conflict candidate knowledge is right.

For example, the existing knowledge repository may comprise multiple pieces of existing correct knowledge (such as, first exiting knowledge, second exiting knowledge, third exiting knowledge, fourth exiting knowledge, and the like shown in FIG. 2B), the multiple pieces of existing correct knowledge may constitute a plurality of consistency evidences 101 (such as, a consistency evidence 101a, a consistency evidence 101b, and the like shown in FIG. 2A). The plurality of consistency evidences 101 may have a plurality of weights W₁ (such as, a weight W₁ₐ, a weight W_{1b} and the like shown in FIG. 2A).

For example, a verification probability of the target candidate knowledge may be a compatibility probability between the target candidate knowledge, the data source, and the existing knowledge repository. That is, the verification probability of the target candidate knowledge is a probability of correctness of the target candidate knowledge. A verification probability of the conflict candidate knowledge may be a compatibility probability between the conflict candidate knowledge, the data source, and the existing knowledge repository. That is, the verification probability of the conflict candidate knowledge is a probability of correctness of the conflict candidate knowledge.

For another example, a verification probability of the target candidate knowledge also may be an incompatibility probability between the target candidate knowledge, the data source, and the existing knowledge repository. That is, the verification probability of the target candidate knowledge is a probability of incorrectness of the target candidate knowledge. A verification probability of the conflict candidate knowledge may be an incompatibility probability between the conflict candidate knowledge, the data source, and the existing knowledge repository. That is, the verification probability of the conflict candidate knowledge is a probability of incorrectness of the conflict candidate knowledge.

It should be noted that, in the embodiments of the present disclosure, the verification probability is a probability of correctness, which is taken as an example for detail descriptions here. However, the verification probability also may be a probability of incorrectness of the target/conflict candidate knowledge. The embodiments of the present disclosure are not limited thereto.

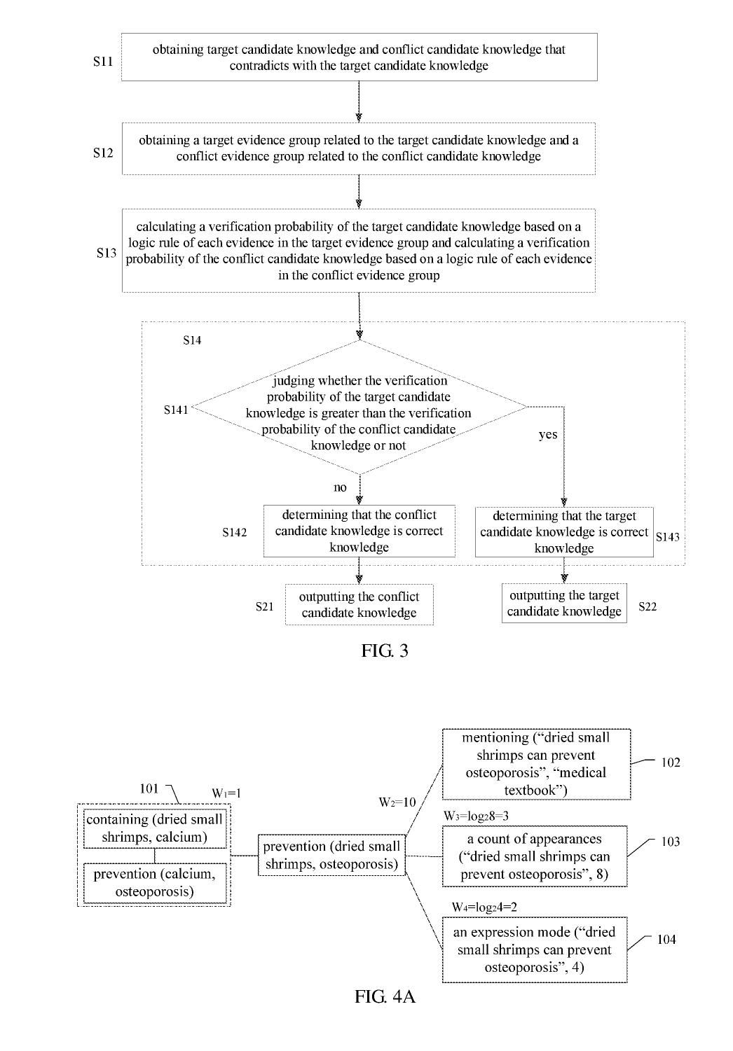

FIG. 3 shows a schematic flow chart of another knowledge verification method provided by an embodiment of the present disclosure.

For example, as shown in FIG. 3, in an example, in a case that the verification probability is a probability of correctness, the step S14 may comprise the following steps:

Step S141: judging whether the verification probability of the target candidate knowledge is greater than the verification probability of the conflict candidate knowledge or not;

if the verification probability of the target candidate knowledge is not greater than the verification probability of the conflict candidate knowledge, executing step S142: determining that the conflict candidate knowledge is correct knowledge;

if the verification probability of the target candidate knowledge is greater than the verification probability of the conflict candidate knowledge, executing step S143: determining that the target candidate knowledge is correct knowledge.

For example, according to logic rules of respective evidences modeled based on the Markov logic network, a verification probability of the target candidate knowledge and a verification probability of the conflict candidate knowledge each can be expressed as:

$$P ( y ) = \frac{1}{Z} exp ( {\sum }_{i = 1}^{T} {w}_{i} \cdot {f}_{i} ( y ) ) \qquad ( 1 )$$

here, Z is a normalization factor. When y represents the target candidate knowledge, P(y) in the above formula (1) is the verification probability of the target candidate knowledge, fᵢ(y) is a logical value of a logic rule of an i-th evidence in the target evidence group, fᵢ(y)=1 indicates that the logic rule of the i-th evidence in the target evidence group is true, fᵢ(y)=0 indicates that the logic rule of the i-th evidence in the target evidence group is false, Wᵢ represents a weight of the i-th evidence in the target evidence group, and T represents a quantity of evidences in the target evidence group. When y represents the conflict candidate knowledge, P(y) in the above formula (1) is the verification probability of the conflict candidate knowledge, fᵢ(y) is a logical value of a logic rule of an i-th evidence in the conflict evidence group, fᵢ(y)=1 indicates that the logic rule of the i-th evidence in the conflict evidence group is true, fᵢ(y)=0 indicates that the logic rule of the i-th evidence in the conflict evidence group is false, Wᵢ represents a weight of the i-th evidence in the conflict evidence group, and T represents a quantity of evidences in the conflict evidence group.

For example, vertexes in Markov logic network are ground predicates or ground atoms, logical relationships among the ground predicates or among ground atoms are ground formulas. Each ground predicate or each ground atom corresponds to a binary node (that is, a feature value of the ground predicate or the ground atom), if a ground predicate or a ground atom is true, a value of a corresponding binary node is 1; and if the ground predicate or the ground atom is false, the value of the corresponding binary node is 0. Each ground formula corresponds to a feature value, if a ground formula is true, a corresponding feature value is 1; if the ground formula is false, the corresponding feature value is 0.

For example, the source evidence 102, the redundancy evidence 103 and the expression mode evidence 104 are ground predicates or ground atoms, and the consistency evidence 101 is a ground formula. For example, for the source evidence 102, the redundancy evidence 103 and the expression mode evidence 104, the logic rule of fᵢ(y) is true, that is fᵢ(y)=1. For the consistency evidence 101, if the target candidate knowledge (or the conflict candidate knowledge) is compatible with the existing correct knowledge, then the logic rule of fᵢ(y) is true, that is fᵢ(y)=1, otherwise fᵢ(y)=0.

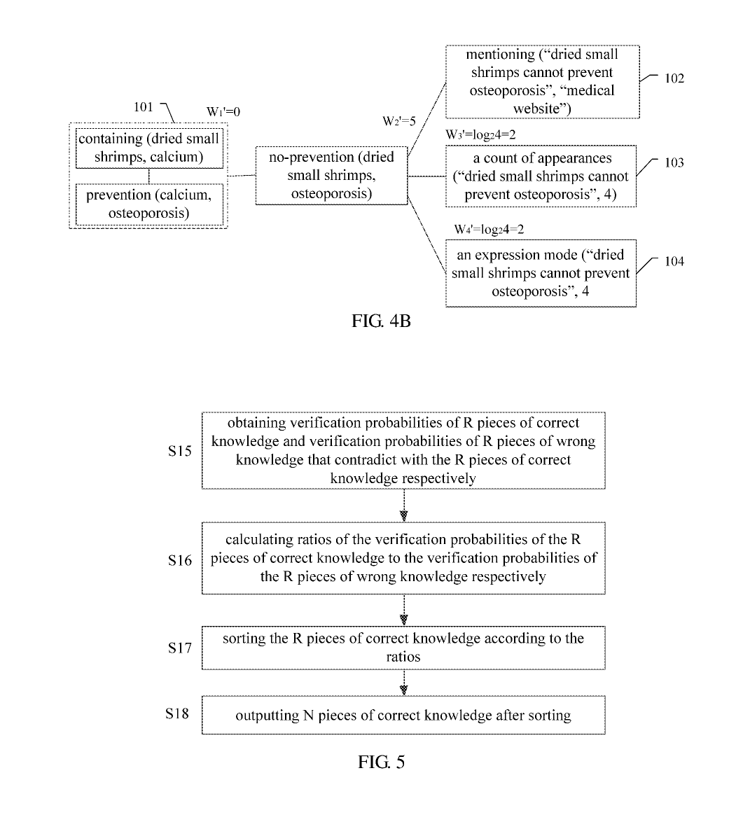

FIG. 4A shows a schematic block diagram of an example of a target evidence group provided by an embodiment of the present disclosure; FIG. 4B shows a schematic block diagram of an example of a conflict evidence group provided by an embodiment of the present disclosure.

For example, in a specific example, a target candidate knowledge is “dried small shrimps can prevent osteoporosis”, and a conflict candidate knowledge is “dried small shrimps cannot prevent osteoporosis”.

For example, as shown in FIG. 4A, a target evidence group comprises: mentioning (“dried small shrimps can prevent osteoporosis”, “medical textbook”), a count of appearances (“dried small shrimps can prevent osteoporosis”, 8), an expression mode (“dried small shrimps can prevent osteoporosis”, 4), and “containing (dried small shrimps, calcium)” ̂“prevention (calcium, osteoporosis)”=>“prevention (dried small shrimps, osteoporosis)”. Therefore, a weight of the source evidence 102 of the target candidate knowledge is W₂=10, a weight of the redundancy evidence 103 of the target candidate knowledge is W₃=log₂8=3, and a weight of the expression mode evidence 104 of the target candidate knowledge is W₄=log₂4=2. The target candidate knowledge (that is, “dried small shrimps can prevent osteoporosis”) does not conflict with the consistency evidence 101, that is, a weight of the consistency evidence 101 of the target candidate knowledge is W₁=1.

For example, as shown in FIG. 4B, a conflict evidence group comprises: mentioning (“dried small shrimps cannot prevent osteoporosis”, “medical website”), a count of appearances (“dried small shrimps cannot prevent osteoporosis”, 4), an expression mode (“dried small shrimps cannot prevent osteoporosis”, 4), and “containing (dried small shrimps, calcium)” A “prevention (calcium, osteoporosis)”=>“prevention (dried small shrimps, osteoporosis)”. Therefore, a weight of the source evidence 102 of the conflict candidate knowledge is W₂′=5, a weight of the redundancy evidence 103 of the conflict candidate knowledge is W₃′=log 24=2, and a weight of the expression mode evidence 104 of the conflict candidate knowledge is W₄′=log₂4=2. The conflict candidate knowledge (that is “dried small shrimps cannot prevent osteoporosis”) conflicts with the consistency evidence 101, that is, a weight of the consistency evidence 101 of the conflict candidate knowledge is W₁′=0.

In summary, in the step S13, based on the logic rules of respective evidences in the target evidence group, the verification probability of the target candidate knowledge can be calculated. The verification probability of the target candidate knowledge is expressed as follows:

$$P ( target candidate knowledge ) = \frac{1}{Z} {e}^{( {W}_{1} + {W}_{2} + {W}_{3} + {W}_{4} )} = \frac{1}{Z} {e}^{( 1 + 10 + 3 + 2 )} = \frac{1}{Z} {e}^{16}$$

Based on the logic rules of respective evidences in the conflict evidence group, the verification probability of the conflict candidate knowledge can be calculated. The verification probability of the conflict candidate knowledge is expressed as follows:

$$P ( conflict candidate knowledge ) = \frac{1}{Z} {e}^{( {W}_{1}^{′} + {W}_{2}^{′} + {W}_{3}^{′} + {W}_{4}^{′} )} = \frac{1}{Z} {e}^{( 0 + 5 + 2 + 2 )} = \frac{1}{Z} {e}^{9}$$

For the target candidate knowledge and the conflict candidate knowledge, Z is the same.

For example, in the step S14, according to a comparison result between the verification probability of the target candidate knowledge and the verification probability of the conflict candidate knowledge, it can be determined whether the target candidate knowledge is correct knowledge or not. For example, in an example shown in FIG. 4A and FIG. 4B,

P(target candidate knowledge)>P(conflict candidate knowledge).

Thus, it can be determined that the target candidate knowledge is correct knowledge.

For example, the knowledge verification method further comprises outputting the correct knowledge. For example, the output correct knowledge can be displayed on a monitor, or can be a voice outputted through a speaker, or the like.

For example, the knowledge verification method can output all or part of the correct knowledge. As shown in FIG. 3A, in an example, the knowledge verification method further comprises the following steps:

after the step S142 is performed, executing step S21: outputting the conflict candidate knowledge;

after the step S143 is performed, executing step S22: outputting the target candidate knowledge.

FIG. 5 shows a schematic flow chart of yet another knowledge verification method provided by an embodiment of the present disclosure.

For example, the knowledge verification method also may output the correct knowledge that a user desires to display, such as, displaying N pieces of correct knowledge. As shown in FIG. 5, in another example, when the step S14 is performed, the knowledge verification method may further perform the following steps:

Step S15: obtaining verification probabilities of R pieces of correct knowledge and verification probabilities of R pieces of wrong knowledge that contradict with the R pieces of correct knowledge respectively;

Step S16: calculating ratios of the verification probabilities of the R pieces of correct knowledge to the verification probabilities of the R pieces of wrong knowledge respectively;

Step S17: sorting the R pieces of correct knowledge according to the ratios;

Step S18: outputting N pieces of correct knowledge after sorting.

For example, in the step S15, multiple pieces of correct knowledge and verification probabilities thereof, and multiple pieces of wrong knowledge and verification probabilities thereof may be determined according to a method shown in FIG. 1 and/or FIG. 3.

For example, the correct knowledge may be the target candidate knowledge, or the conflict candidate knowledge; correspondingly, the wrong knowledge may be the conflict candidate knowledge, or the target candidate knowledge.

For example, a ratio may be expressed as follows:

P(correct knowledge)/P(wrong knowledge)

here, P(correct knowledge) may be P(target candidate knowledge), or P(conflict candidate knowledge); correspondingly, P(wrong knowledge) may be P(conflict candidate knowledge), or P(target candidate knowledge).

For example, N is a positive integer, and N≤R. N may be the quantity of the correct knowledge that the user expects to display. N may be related to the quantity of candidate knowledge in the candidate knowledge group, and N, for example, may be 10% of the quantity of candidate knowledge. The embodiments of the present disclosure do not specifically limit N.

For example, the N pieces of correct knowledge may correspond to the N largest ratios. For example, the N pieces of correct knowledge may be the target candidate knowledge that corresponds to the N largest ratios. However the embodiments of the present disclosure are not limited thereto, the N pieces of correct knowledge may also correspond to the N smallest ratios.

For example, the R pieces of correct knowledge may be all correct knowledge, that is, R is the number of all correct knowledge; the R pieces of correct knowledge also may be a part of the correct knowledge.

For example, the knowledge verification method provided by an embodiment of the present disclosure may further output information such as a ratio of each correct knowledge, a verification probability of the correct knowledge and the like. It should be noted that, the knowledge verification method provided by an embodiment of the present disclosure also may output the wrong knowledge.

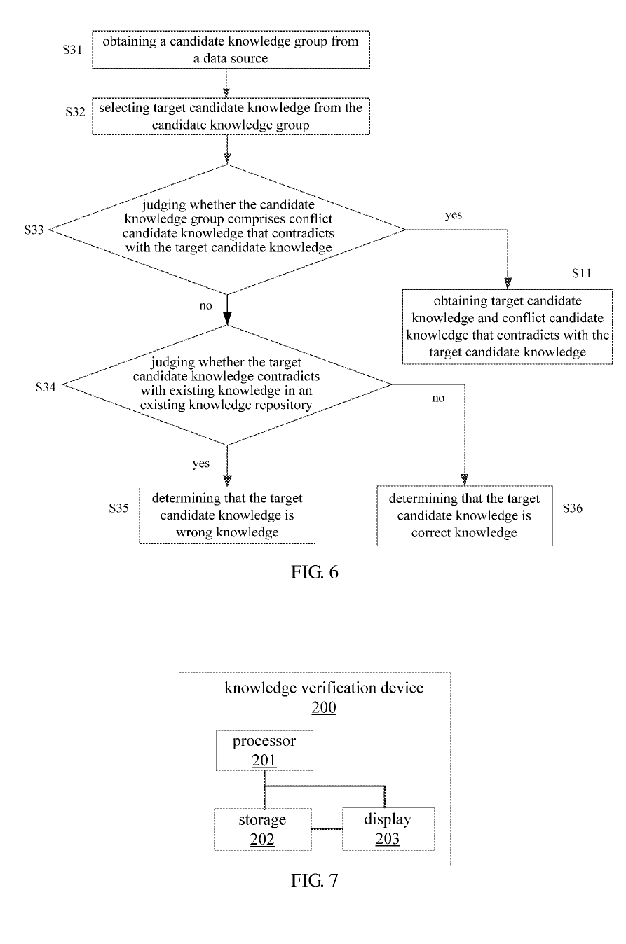

FIG. 6 shows a schematic flow chart of still yet another knowledge verification method provided by an embodiment of the present disclosure.

For example, as shown in FIG. 6, in an example, before the step 11 shown in FIG. 1 is performed, the knowledge verification method may further comprise the following steps:

Step S31: obtaining a candidate knowledge group from a data source;

Step S32: selecting target candidate knowledge from the candidate knowledge group;

Step S33: judging whether the candidate knowledge group comprises conflict candidate knowledge that contradicts with the target candidate knowledge; if the candidate knowledge group comprises the conflict candidate knowledge, proceeding to the step S11; if the candidate knowledge group does not comprise the conflict candidate knowledge, executing step S34 which includes judging whether the target candidate knowledge contradicts with existing knowledge in an existing knowledge repository; if the target candidate knowledge contradicts with the existing knowledge, executing step S35 which includes determining that the target candidate knowledge is wrong knowledge; and if the target candidate knowledge does not contradict with the existing knowledge, executing step S36 which includes determining that the target candidate knowledge is correct knowledge.

For example, in a case that the candidate knowledge group includes all candidate knowledge in the data source, when it is determined that the target candidate knowledge is correct knowledge, it means that both the data source and the existing knowledge repository do not comprise knowledge that contradicts with the target candidate knowledge. Therefore, it can be directly determined that the target candidate knowledge is correct knowledge, and the target candidate knowledge is output as needed.

For another example, in a case that the candidate knowledge group includes multiple pieces of candidate knowledge extracted from the data source, when it is determined that the target candidate knowledge (or conflict candidate knowledge) is correct knowledge, that is, after performing the step S142 or the step S143 shown in FIG. 3 or the step S36 shown in FIG. 6, the target candidate knowledge (or conflict candidate knowledge) may be stored in a correct knowledge group. Thus, outputting the correct knowledge may comprise the following steps: obtaining the correct knowledge from the correct knowledge group; constructing wrong knowledge that contradicts with the correct knowledge; obtaining a correct evidence group related to the correct knowledge and a wrong evidence group related to the wrong knowledge; calculating verification probabilities of the correct knowledge based on logic rules of respective evidences in the correct evidence group; calculating verification probabilities of the wrong knowledge based on logic rules of respective evidences in the wrong evidence group; calculating ratios of the verification probabilities of the correct knowledge to the verification probabilities of the corresponding wrong knowledge respectively; sorting the correct knowledge according to the ratios; outputting N pieces of correct knowledge after sorting.

It should be noted that, in order to reduce computational complexity, when the candidate knowledge group comprises both the target candidate knowledge and the conflict candidate knowledge that contradicts with the target candidate knowledge, that is, the correct knowledge is correct knowledge verified by the method shown in FIG. 1 and/or FIG. 3, the verification probabilities of the correct knowledge and the verification probabilities of the wrong knowledge can be directly obtained (for example, referring to the step 13 shown in FIG. 1 and/or FIG. 3), so that the ratios of the verification probabilities of the correct knowledge to the verification probabilities of the wrong knowledge can be directly calculated; or the ratios of the verification probabilities of the correct knowledge to the verification probabilities of the wrong knowledge may also be directly obtained (for example, referring to the step S16 shown in FIG. 5). And then the correct knowledge is sorted according to the ratios.

FIG. 7 is a schematic block diagram of a knowledge verification device provided by an embodiment of the present disclosure.

For example, as shown in FIG. 7, a knowledge verification device 200 provided by an embodiment of the present disclosure may comprise a processor 201, a storage 202 and a display 203. It should be noted that the components and structures of the knowledge verification device shown in FIG. 7 are merely exemplary and not limitative, and according to the actual application needs, the knowledge verification device may also comprise other components and structures.

For example, the processor 201, the storage 202, the display 203 and other components may be connected and communicated with each other through a network. The processor 201, the storage 202, the display 203 and other components may be directly or indirectly communicated with each other.

For example, the network may comprise a wireless network, a wired network, and/or any combination of the wireless network and the wired network. The network may comprise a local area network, the Internet, a telecommunication network, Internet of things based on the Internet and/or the telecommunication network, and/or any combination of the above networks, and the like. For example, the wired network may adopt communication means such as a twisted pair, coaxial cable or optical fiber transmission. The wireless network may adopt communication means such as 3G/4G/5G mobile communication networks, Bluetooth, Zigbee or WiFi. The present disclosure does not limit types and functions of the network herein.

For example, the processor 201 may be a central processing unit (CPU) or other forms of processing units having data processing capabilities and/or program execution capabilities, such as a field-programmable gate array (FPGA), or a tensor processing unit (TPU), and the processor 201 may control other components in the knowledge verification device 200 to perform desired functions. For another example, the central processing unit (CPU) may be X86, ARM architecture, or the like.

For example, the storage 202 may comprise an arbitrary combination of one or more computer program products. The computer program products may comprise various forms of computer-readable storage media, such as volatile memory and/or non-volatile memory. The volatile memory may comprise, for example, a random access memory (RAM) and/or a cache or the like. The non-volatile memory may comprise, for example, a read only memory (ROM), a hard disk, an erasable programmable read only memory (EPROM), a compact disc-read only memory (CD-ROM), a USB memory, a flash memory, and the like. One or more computer instructions may be stored on the storage 202, and the processor 201 may execute the computer instructions to implement various functions. Various application programs and various data, such as a data source, an existing knowledge repository, weights, verification probabilities of target candidate knowledge, verification probabilities of conflict candidate knowledge, and various data used and/or generated by the application programs, and the like, may also be stored in the computer-readable storage medium.

For example, the display 203 may be a liquid crystal display (LCD), an organic light-emitting diode display (OLED), and the like.

It should be noted that, in some embodiments, according to actual needs, the knowledge verification device 200 may further comprise an input device (such as, a touch device, a keyboard, a microphone, a mouse, etc.), a speaker, and the like. A user may use the display 203, the input device and the like to achieve interaction with the knowledge verification device 200. For example, the user may check the correct knowledge through the display 203, and may also input candidate knowledge that needs to be verified and the like through the input device,

For example, the computer instructions, as executed by the processor 201, cause the processor 201 to perform steps including: obtaining target candidate knowledge and conflict candidate knowledge that contradicts with the target candidate knowledge; obtaining a target evidence group related to the target candidate knowledge and a conflict evidence group related to the conflict candidate knowledge; calculating a verification probability of the target candidate knowledge based on logic rules of respective evidences in the target evidence group and calculating a verification probability of the conflict candidate knowledge based on logic rules of respective evidences in the conflict evidence group; and comparing the verification probability of the target candidate knowledge with the verification probability of the conflict candidate knowledge and determining whether the target candidate knowledge is correct or not according to a comparison result.

For example, a natural language processing (NLP) technology can be used to extract the target candidate knowledge and the conflict candidate knowledge. The natural language processing technology can perform language processing by using deep learning neural networks (such as, recurrent neural networks, recursive neural networks and so on) and other methods.

For example, each of a target evidence group and a conflict evidence group may comprise at least one of a source evidence, a redundancy evidence and an expression mode evidence, and the source evidence, the redundancy evidence and the expression mode evidence all may be obtained from data sources. For another example, the target evidence group and the conflict evidence group each may also respectively comprise a consistency evidence, and the consistency evidence is obtained from an existing knowledge repository.

For example, a logic rule of the source evidence may be expressed as: mentioning (y, s); a logic rule of the redundancy evidence may be expressed as: the count of appearances (y, N); a logic rule of the expression mode evidence may be expressed as: an expression mode (y, M); and a logic rule of the consistency evidence may be expressed as: first existing knowledge ̂second existing knowledge=>y. In a case that y represents the target candidate knowledge, S represents a source of the target candidate knowledge, N represents the number of appearances of the target candidate knowledge, M represents a quantity of different expression modes of the target candidate knowledge; in a case that y represents the conflict candidate knowledge, S represents a source of the conflict candidate knowledge, N represents the number of appearances of the conflict candidate knowledge, M represents a quantity of different expression modes of the conflict candidate knowledge.

For example, a weight of the source evidence may be expressed as a degree of authority of S, a weight of the redundancy evidence may be expresses as logₐN, a weight of the expression mode evidence may be expressed as logₐM, logₐ represents a logarithmic function with “a” as a base, and a weight of the consistency evidence may be expressed as a logical value of the logic rule of the consistency evidence.

For example, the embodiments of the present disclosure may model logic rules of evidences through a Markov logic network, and calculates the verification probabilities of the target candidate knowledge (or conflict candidate knowledge) according to the logic rules of evidences. For example, according to logic rules of respective evidences modeled based on the Markov logic network, a verification probability of target candidate knowledge and a verification probability of conflict candidate knowledge each can be expressed as:

$$P ( y ) = \frac{1}{Z} exp ( {\sum }_{i = 1}^{T} {w}_{i} \cdot {f}_{i} ( y ) ) ,$$

here, Z is a normalization factor. When y represents the target candidate knowledge, P(y) is the verification probability of the target candidate knowledge, fᵢ(y) is a logical value of a logic rule of an i-th evidence in the target evidence group, fᵢ(y)=1 indicates that the logic rule of the i-th evidence in the target evidence group is true, fᵢ(y)=0 indicates that the logic rule of the i-th evidence in the target evidence group is false, Wᵢ represents a weight of the i-th evidence in the target evidence group, and T represents a quantity of evidences in the target evidence group; when y represents the conflict candidate knowledge, P(y) is the verification probability of the conflict candidate knowledge, fᵢ(y) is a logical value of a logic rule of an i-th evidence in the conflict evidence group, fᵢ(y)=1 indicates that the logic rule of the i-th evidence in the conflict evidence group is true, fᵢ(y)=0 indicates that the logic rule of the i-th evidence in the conflict evidence group is false, Wᵢ represents a weight of the i-th evidence in the conflict evidence group, and T represents a quantity of evidences in the conflict evidence group.

For example, in an example, in a case that the verification probability is a probability of correctness, the non-transitory computer-readable instructions, as executed by the processor 201, cause the processor 201 to perform a step of “comparing the verification probability of the target candidate knowledge with the verification probability of the conflict candidate knowledge and determining whether the target candidate knowledge is correct or not according to a comparison result” including: judging whether the verification probability of the target candidate knowledge is greater than the verification probability of the conflict candidate knowledge; if the verification probability of the target candidate knowledge is not greater than the verification probability of the conflict candidate knowledge, determining that the conflict candidate knowledge is correct knowledge; if the verification probability of the target candidate knowledge is greater than the verification probability of the conflict candidate knowledge, determining that the target candidate knowledge is correct knowledge.

For example, in an example, the computer instructions, as executed by the processor 201, may further cause the processor 201 to perform steps including: obtaining verification probabilities of R pieces of correct knowledge and verification probabilities of R pieces of wrong knowledge that contradicts with the R pieces of correct knowledge; calculating ratios of the verification probabilities of the R pieces of correct knowledge to the verification probabilities of the R pieces of wrong knowledge respectively; sorting the R pieces of correct knowledge according to the ratios; and outputting N pieces of correct knowledge after sorting.

For example, N is a positive integer, and N≤R. N may be the quantity of correct knowledge that the user expects to display.

For example, in an example, the computer instructions, as executed by the processor 201, may further cause the processor 201 to perform steps including: outputting the sorted N pieces of correct knowledge to the display 203; and displaying the sorted N pieces of correct knowledge on the display 203.

For example, the N pieces of correct knowledge may correspond to the N largest ratios.

For example, in an example, the non-transitory computer-readable instructions, as executed by the processor 201, may further cause the processor 201 to perform steps including: obtaining a candidate knowledge group from a data source; selecting target candidate knowledge from the candidate knowledge group; judging whether the candidate knowledge group comprises conflict candidate knowledge that contradicts with the target candidate knowledge; if the candidate knowledge group comprises the conflict candidate knowledge, calculating a verification probability of the target candidate knowledge and a verification probability of the conflict candidate knowledge, and determining whether the target candidate knowledge is correct knowledge or not according to a comparison result between the verification probability of the target candidate knowledge and the verification probability of the conflict candidate knowledge; if the candidate knowledge group does not comprise the conflict candidate knowledge, judging whether the target candidate knowledge contradicts with existing knowledge in an existing knowledge repository, if the target candidate knowledge contradicts with the existing knowledge, determining that the target candidate knowledge is wrong knowledge, and if the target candidate knowledge does not contradict with the existing knowledge, determining that the target candidate knowledge is correct knowledge.

For example, in an example, when it is determined that the target candidate knowledge (or conflict candidate knowledge) is correct knowledge, the target candidate knowledge (or conflict candidate knowledge) may be stored in a correct knowledge group. The computer instructions, as executed by the processor 201, may further cause the processor 201 to perform steps including: obtaining the correct knowledge from the correct knowledge group; constructing wrong knowledge that contradicts with the correct knowledge; obtaining a correct evidence group related to the correct knowledge and a wrong evidence group related to the wrong knowledge; calculating verification probabilities of the correct knowledge based on logic rules of respective evidences in the correct evidence group; calculating verification probabilities of the wrong knowledge based on logic rules of respective evidences in the wrong evidence group; calculating ratios of the verification probabilities of the correct knowledge to the verification probabilities of the corresponding wrong knowledge respectively; sorting the correct knowledge according to the ratios; outputting N pieces of the sorted correct knowledge.

It should be noted that, relevant detailed descriptions of the data source, the existing knowledge repository, the source evidence, the redundancy evidence, the expression mode evidence, the consistency evidence and the like can be referred to in related descriptions in the embodiments of the knowledge verification method, and similar descriptions will be omitted here.

At least one embodiment of the present disclosure further provides a storage medium, which stores non-transitory computer instructions. The non-transitory computer instructions, as executed by a processor, cause the processor to perform steps including: obtaining target candidate knowledge and conflict candidate knowledge that contradicts with the target candidate knowledge; obtaining a target evidence group related to the target candidate knowledge and a conflict evidence group related to the conflict candidate knowledge; calculating a verification probability of the target candidate knowledge based on logic rules of respective evidences in the target evidence group and calculating a verification probability of the conflict candidate knowledge based on logic rules of respective evidences in the conflict evidence group; and comparing the verification probability of the target candidate knowledge with the verification probability of the conflict candidate knowledge and determining whether the target candidate knowledge is correct or not according to a comparison result.

For example, in an example of the embodiments of the present disclosure, the storage medium may be applied in the knowledge verification device described in any one of the above embodiments. For example, the storage medium may be the storage 202 of the knowledge verification device.

For example, the description of the storage medium may be referred to in the descriptions of the storage 202 in the embodiments of the knowledge verification device, and similar descriptions will be omitted here.

For the present disclosure, the following statements should be noted:

(1) the accompanying drawings involve only the structure(s) in connection with the embodiment(s) of the present disclosure, and other structure(s) can be referred to in common design(s); and

(2) in a case with no conflict, the embodiments of the present disclosure and the features in the embodiment(s) can be combined with each other to obtain new embodiment(s).

What have been described above are only specific implementations of the present disclosure, the protection scope of the present disclosure is not limited thereto, and the protection scope of the present disclosure should be based on the protection scope of the claims.

What is claimed is:

1. A knowledge verification method, comprising:
obtaining target candidate knowledge and conflict candidate knowledge that contradicts with the target candidate knowledge;
obtaining a target evidence group related to the target candidate knowledge and a conflict evidence group related to the conflict candidate knowledge;
based on a logic rule of each evidence in the target evidence group, calculating a verification probability of the target candidate knowledge, and based on a logic rule of each evidence in the conflict evidence group, calculating a verification probability of the conflict candidate knowledge; and
comparing the verification probability of the target candidate knowledge with the verification probability of the conflict candidate knowledge, and determining whether the target candidate knowledge is correct knowledge or not according to a comparison result.

2. The knowledge verification method according to claim 1, wherein the target evidence group and the conflict evidence group each comprise at least one of a source evidence, a redundancy evidence and an expression mode evidence, and the source evidence, the redundancy evidence and the expression mode evidence are obtained from a data source.

3. The knowledge verification method according to claim 2, wherein the target evidence group and the conflict evidence group each further comprise a consistency evidence, and the consistency evidence is obtained from an existing knowledge repository.

4. The knowledge verification method according to claim 3, wherein,
a logic rule of the source evidence is expressed as: mentioning (y, s);
a logic rule of the redundancy evidence is expressed as: a count of appearances (y, N);
a logic rule of the expression mode evidence is expressed as: an expression mode (y, M); and
a logic rule of the consistency evidence is expressed as: first existing knowledge ̂second existing knowledge=>y,
wherein in a case that y represents the target candidate knowledge, S represents a source of the target candidate knowledge, N represents a count of appearances of the target candidate knowledge, and M represents a quantity of different expression modes of the target candidate knowledge;
in a case that y represents the conflict candidate knowledge, S represents a source of the conflict candidate knowledge, N represents a count of appearances of the conflict candidate knowledge, and M represents a quantity of different expression modes of the conflict candidate knowledge;
a weight of the source evidence is represented as a degree of authority of S, a weight of the redundancy evidence is represented as logₐN, a weight of the expression mode evidence is represented as logₐM, and a weight of the consistency evidence is represented as a logical value of the logic rule of the consistency evidence.

5. The knowledge verification method according to claim 4, wherein the verification probability of the target candidate knowledge and the verification probability of the conflict candidate knowledge each are expressed as:
$$P ( y ) = \frac{1}{Z} exp ( {\sum }_{i = 1}^{T} {w}_{i} \cdot {f}_{i} ( y ) )$$
wherein Z is a normalization factor,
in a case that y represents the target candidate knowledge, fᵢ(y) is a logical value of a logic rule of an i-th evidence in the target evidence group, fᵢ(y)=1 indicates that the logic rule of the i-th evidence in the target evidence group is true, fᵢ(y)=0 indicates that the logic rule of the i-th evidence in the target evidence group is false, Wᵢ represents a weight of the i-th evidence in the target evidence group, and T represents a quantity of evidences in the target evidence group;
in a case that y represents the conflict candidate knowledge, fᵢ(y) is a logical value of a logic rule of an i-th evidence in the conflict evidence group, fᵢ(y)=1 indicates that the logic rule of the i-th evidence in the conflict evidence group is true, fᵢ(y)=0 indicates that the logic rule of the i-th evidence in the conflict evidence group is false, Wᵢ represents a weight of the i-th evidence in the conflict evidence group, and T represents a quantity of evidences in the conflict evidence group.

6. The knowledge verification method according to claim 1, wherein the verification probability is a probability of correctness,
the comparing the verification probability of the target candidate knowledge with the verification probability of the conflict candidate knowledge and determining whether the target candidate knowledge is correct knowledge or not according to the comparison result comprises:
judging whether the verification probability of the target candidate knowledge is greater than the verification probability of the conflict candidate knowledge, if not, determining that the conflict candidate knowledge is correct knowledge and the target candidate knowledge is wrong knowledge, and outputting the conflict candidate knowledge; if yes, determining that the target candidate knowledge is correct knowledge and the conflict candidate knowledge is wrong knowledge, and outputting the target candidate knowledge.

7. The knowledge verification method according to claim 1, further comprising:
obtaining verification probabilities of R pieces of correct knowledge and verification probabilities of R pieces of wrong knowledge that contradict with the R pieces of correct knowledge;
calculating ratios of the verification probabilities of the R pieces of correct knowledge to the verification probabilities of the R pieces of wrong knowledge respectively;
sorting the R pieces of correct knowledge according to the ratios; and
outputting N pieces of correct knowledge after sorting, wherein N is a positive integer, and N≤R.

8. The knowledge verification method according to claim 7, wherein the N pieces of correct knowledge corresponds to N largest ratios.

9. A knowledge verification device, comprising a processor and a storage, the storage is used for storing non-transitory computer instructions, wherein the non-transitory computer instructions, as executed by the processor, cause the processor to perform steps including:
obtaining target candidate knowledge and conflict candidate knowledge that contradicts with the target candidate knowledge;
obtaining a target evidence group related to the target candidate knowledge and a conflict evidence group related to the conflict candidate knowledge;
based on a logic rule of each evidence in the target evidence group, calculating a verification probability of the target candidate knowledge, and based on a logic rule of each evidence in the conflict evidence group, calculating a verification probability of the conflict candidate knowledge; and
comparing the verification probability of the target candidate knowledge with the verification probability of the conflict candidate knowledge and determining whether the target candidate knowledge is correct knowledge or not according to a comparison result.

10. The knowledge verification device according to claim 9, wherein the target evidence group and the conflict evidence group each comprise at least one of a source evidence, a redundancy evidence and an expression mode evidence, and the source evidence, the redundancy evidence and the expression mode evidence are obtained from a data source.

11. The knowledge verification device according to claim 10, wherein the target evidence group and the conflict evidence group each further comprise a consistency evidence, and the consistency evidence is obtained from an existing knowledge repository.

12. The knowledge verification device according to claim 11, wherein:
a logic rule of the source evidence is expressed as: mentioning (y, s);
a logic rule of the redundancy evidence is expressed as: a count of appearances (y, N);
a logic rule of the expression mode evidence is expressed as: an expression mode (y, M); and
a logic rule of the consistency evidence is expressed as: first existing knowledge A second existing knowledge=>y,
wherein in a case that y represents the target candidate knowledge, S represents a source of the target candidate knowledge, N represents a count of appearances of the target candidate knowledge, and M represents a quantity of different expression modes of the target candidate knowledge;
in a case that y represents the conflict candidate knowledge, S represents a source of the conflict candidate knowledge, N represents a count of appearances of the conflict candidate knowledge, and M represents a quantity of different expression modes of the conflict candidate knowledge;
a weight of the source evidence is represented as a degree of authority of S, a weight of the redundancy evidence is represented as logₐN, a weight of the expression mode evidence is represented as logₐM, and a weight of the consistency evidence is represented as a logical value of the logic rule of the consistency evidence.

13. The knowledge verification device according to claim 12, wherein the verification probability of the target candidate knowledge and the verification probability of the conflict candidate knowledge each are expressed as:
$$P ( y ) = \frac{1}{Z} exp ( {\sum }_{i = 1}^{T} {w}_{i} \cdot {f}_{i} ( y ) )$$
wherein Z is a normalization factor,
in a case that y represents the target candidate knowledge, fᵢ(y) is a logical value of a logic rule of an i-th evidence in the target evidence group, fᵢ(y)=1 indicates that the logic rule of the i-th evidence in the target evidence group is true, fᵢ(y)=0 indicates that the logic rule of the i-th evidence in the target evidence group is false, Wᵢ represents a weight of the i-th evidence in the target evidence group, and T represents a quantity of evidences in the target evidence group; and
in a case that y represents the conflict candidate knowledge, fᵢ(y) is a logical value of a logic rule of an i-th evidence in the conflict evidence group, fᵢ(y)=1 indicates that the logic rule of the i-th evidence in the conflict evidence group is true, fᵢ(y)=0 indicates that the logic rule of the i-th evidence in the conflict evidence group is false, Wᵢ represents a weight of the i-th evidence in the conflict evidence group, and T represents a quantity of evidences in the conflict evidence group.

14. The knowledge verification device according to claim 9, wherein the non-transitory computer instructions, as executed by the processor, further cause the processor to perform steps including:
obtaining verification probabilities of R pieces of correct knowledge and verification probabilities of R pieces of wrong knowledge that contradict with the R pieces of correct knowledge;
calculating ratios of the verification probabilities of the R pieces of correct knowledge to the verification probabilities of the R pieces of wrong knowledge respectively;
sorting the R pieces of correct knowledge according to the ratios; and
outputting N pieces of correct knowledge after sorting, wherein N is a positive integer, and N≤R.

15. The knowledge verification device according to claim 14, further comprising a display,
wherein the non-transitory computer instructions, as executed by the processor, further cause the processor to perform steps including:
outputting the N pieces of correct knowledge to the display; and
displaying the N pieces of correct knowledge on the display.

16. The knowledge verification device according to claim 14, wherein the N pieces of correct knowledge corresponds to N largest ratios.

17. The knowledge verification device according to claim 9, wherein the verification probability is a probability of correctness,
the non-transitory computer instructions, as executed by the processor, cause the processor to perform the step of “comparing the verification probability of the target candidate knowledge with the verification probability of the conflict candidate knowledge and determining whether the target candidate knowledge is correct knowledge or not according to the comparison result” including:
judging whether the verification probability of the target candidate knowledge is greater than the verification probability of the conflict candidate knowledge, if not, determining that the conflict candidate knowledge is correct knowledge and the target candidate knowledge is wrong knowledge, and outputting the conflict candidate knowledge; if yes, determining that the target candidate knowledge is correct knowledge and the conflict candidate knowledge is wrong knowledge, and outputting the target candidate knowledge.

18. A storage medium, used for storing non-transitory computer instructions, wherein the non-transitory computer instructions, as executed by a processor, cause the processor to perform steps including:
obtaining target candidate knowledge and conflict candidate knowledge that contradicts with the target candidate knowledge;
obtaining a target evidence group related to the target candidate knowledge and a conflict evidence group related to the conflict candidate knowledge;
based on a logic rule of each evidence in the target evidence group, calculating a verification probability of the target candidate knowledge, and based on a logic rule of each evidence in the conflict evidence group, calculating a verification probability of the conflict candidate knowledge; and
comparing the verification probability of the target candidate knowledge with the verification probability of the conflict candidate knowledge and determining whether the target candidate knowledge is correct knowledge or not according to a comparison result.

19. The storage medium according to claim 18, wherein the non-transitory computer instructions, as executed by the processor, further cause the processor to perform steps including:
obtaining verification probabilities of R pieces of correct knowledge and verification probabilities of R pieces of wrong knowledge that contradict with the R pieces of correct knowledge;
calculating ratios of the verification probabilities of the R pieces of correct knowledge to the verification probabilities of the R pieces of wrong knowledge respectively;
sorting the R pieces of correct knowledge according to the ratios; and
outputting N pieces of correct knowledge after sorting, wherein N is a positive integer, and N≤R.

20. The storage medium according to claim 19, wherein the non-transitory computer instructions, as executed by the processor, further cause the processor to perform steps including:
displaying the N pieces of correct knowledge.
